(19) United States
(12) Patent Application Publication
(10) Pub. No.: US 2026/0260450 A1
(43) Pub. Date: Sep. 3, 2026

(54) METHOD, DEVICE AND SYSTEM FOR DETECTING DYNAMIC OCCLUSION

(71) Applicant: Grabtaxi Holdings Pte. Ltd., Singapore (SG)

(72) Inventors: Zhengmin XU, Singapore (SG); Andrei GEORGESCU, Singapore (SG); Padarn George WILSON, Singapore (SG); Nuo XU, Singapore (SG); Xiaocheng HUANG, Singapore (SG)

(21) Appl. No.: 18/872,849

(22) PCT Filed: Jun. 1, 2023
(86) PCT No.: PCT/SG2023/050391

§ 371 Date: Dec. 9, 2024

(30) Foreign Application Priority Data
Jul. 1, 2022 (SG) 10202250352P

(51) Int. Cl. G06V 10/26; G06T 7/50; G06T 7/62; G06T 7/73; G06V 10/82; G06V 20/70

(52) U.S. Cl. CPC G06V 10/26; G06T 7/50; G06T 7/62; G06T 7/74; G06V 10/82; G06V 20/70; G06T 2207/20084; G06T 2207/30244

(57) ABSTRACT

Aspects concern a method for detecting dynamic occlusion on one or more images associated with a location of interest comprising the steps of: receiving a plurality of image data files associated with a location of interest, each image data file associated with at least a part of the location of interest; for each image determining the position and orientation of an image capturing device relative to the location of interest and generating camera pose information; generating a corresponding depth map; generating a corresponding semantic segmentation; grouping the image, camera pose information, depth map and semantic segmentation based on coordinates of the location of interest to form an image group; generating a voxel grid associated with the image group; and determining whether each voxel in the voxel grid is in a dynamically occluded state.

### TECHNICAL FIELD

Various aspects of this disclosure relate to methods, devices and systems for detecting dynamic occlusion.

### BACKGROUND

Street view imagery is pertinent information to many mapping applications. The quality of the map is typically dependent on the quality of the input images, which ideally should capture as much information in the real world as possible. However, dynamic objects on the road, such as moving vehicles, pedestrians, temporary barriers, objects, etc. that are captured as part of the input images may occlude the street view in some cases and cause loss of salient information on the map. Such occlusion, also known as dynamic occlusion, can affect the relevancy and updating of the map because dynamic occlusion may cause failures to detect a new road, a new traffic sign, and/or a place of interest (POI).

One method to mitigate dynamic occlusion involves collecting images at increased frequencies and updating the input images regularly, with the hope that the objects causing the dynamic occlusion in one input image may no longer be occluding in another input image. However, this is relatively more expensive to conduct on a large scale and cannot guarantee zero occlusion. Another method utilizes the use of computer vision technology to detect dynamic occlusions in various applications such as object tracking, augmented reality (AR) applications, robot exploration and mapping.

Existing methods for detecting dynamic occlusion may be complex and/or require relatively large amount of computing resources. There exists a need to provide a more cost-effective solution.

### SUMMARY

The technical solution seeks to provide a method, device and/or system for detection of dynamic occlusion in one or more images. A computer-vision-based system is proposed to detect dynamic occlusion from street view images and output the 3-dimensional coordinates of the occluded space. The system can output the coordinates of the points in the dynamically occluded state and save the voxel grid state array for future updates. These coordinates, represented as latitude, longitude and altitude, can be used for targeted image re-collection.

According to an aspect of the disclosure there is provided a method for detecting dynamic occlusion on one or more images associated with a location of interest comprising the steps of: receiving a plurality of image data files associated with a location of interest, each image data file associated with at least a part of the location of interest; for each image, determining the position and orientation of an image capturing device relative to the location of interest and generating device pose information; generating a corresponding depth map; generating a corresponding semantic segmentation; grouping the image, camera pose information, depth map and semantic segmentation based on coordinates of the location of interest to form an image group; generating a voxel grid associated with the image group; and determining whether each voxel in the voxel grid is in a dynamically occluded state.

In some embodiments, the step of determining whether each voxel in the voxel grid is in a dynamically occluded state includes selecting a state from a set of states comprising the following: unseen, dynamically occluded, void, and occupied.

In some embodiments, the method further comprises the step of generating a voxel grid state array comprising the states of the each of the voxel in the voxel grid.

In some embodiments, the voxel grid state array is a one-dimensional array.

In some embodiments, wherein the voxel grid state array is at an initialization state, the state of every voxel is set to the unseen state.

In some embodiments, the method further comprises the step of reprojecting the voxel onto a two-dimensional image plane based on the camera pose information, and obtaining an associated two-dimensional pixel.

In some embodiments, the method further comprises a step of determining if the pixel is out of an image border specified by image resolution, and assigning the dynamic occluded state to the voxel if the associated pixel is determined to be within the image border.

In some embodiments, the method further comprises comparing a first parameter dᵥ representing a depth of the voxel point with respect to the image capturing device, with a second parameter dₚ representing the depth of the reprojected pixel, wherein if dᵥ is less than or equal to dₚ, the voxel is assigned the void state.

In some embodiments, the method further comprises checking if the segmentation label of the reprojected pixel is a dynamic object, and if not, the voxel will be assigned the occupied state.

In some embodiments, the step of grouping comprises matching the location of interest with at least one feature on a reference map. The step of generating a voxel grid may comprise determining a length, a width and a height of the voxel grid based on the at least one feature on the reference map.

In some embodiments, the step of generating the corresponding depth map of the image comprises using a trained deep learning model or a structure-from-motion (SfM) algorithm to estimate the depth map using the image as the only input.

In some embodiments, the step of generating a corresponding semantic segmentation of the image comprises using a trained convolutional neural network model to generate semantic labels associated with one or more features on the image.

According to another aspect of the disclosure there is provided a device for detecting dynamic occlusion on one or more images associated with a location of interest comprising an input module configured to receive a plurality of image data files associated with a location of interest; a device pose module configured to determine the position and orientation of an image capturing device relative to the location of interest and generating device pose information; a depth map generation module configured to generate a corresponding depth map; a segmentation module configured to generate a corresponding semantic segmentation; an image aggregator module configured to group the image, camera pose information, depth map and semantic segmentation based on coordinates of the location of interest to form an image group; a voxel grid state estimator configured to generate a voxel grid associated with the image group; and determine whether each voxel in the voxel grid is in a dynamically occluded state.

In some embodiments, the determination of whether each voxel in the voxel grid is in a dynamically occluded state includes selecting a state from a set of states comprising the following: unseen state, dynamically occluded state, void state, and occupied state.

In some embodiments, the voxel grid state estimator is further configured to generate a voxel grid state array comprising the states of the each of the voxel in the voxel grid.

In some embodiments, the voxel grid state array is a one-dimensional array.

According to another aspect of the disclosure there is provided a system for updating a voxel grid state array comprising the device as defined, the system further comprise an updater to check if the voxel is previously detected to be in a dynamic occluded state and subsequently in a void state or occupied state.

In some embodiments, if the voxel is detected to be in a void state or occupied state, the system is configured to update the voxel grid state array associated with the change of state(s).

According to another aspect of the disclosure there is a non-transitory computer-readable storage medium comprising instructions, which, when executed by one or more processors, cause the execution of the method as defined.

### BRIEF DESCRIPTION OF THE DRAWINGS

The disclosure will be better understood with reference to the detailed description when considered in conjunction with the non-limiting examples and the accompanying drawings, in which:

FIG. 1 is a flow diagram of a method for detecting dynamic occlusion in accordance with various embodiments;

FIG. 2 is a block diagram depicting various components of a system for detection of dynamic occlusion in accordance with various embodiments;

FIG. 3 is a flow diagram of a method for updating a voxel grid state array;

FIGS. 4A to 4D show the application of the method and system on a location of interest and associated feature of an examplary road segment; and

FIG. 5 shows a schematic illustration of a processor for processing image data for detecting dynamic occlusion in accordance with some embodiments.

### DETAILED DESCRIPTION

The following detailed description refers to the accompanying drawings that show, by way of illustration, specific details and embodiments in which the disclosure may be practiced. These embodiments are described in sufficient detail to enable those skilled in the art to practice the disclosure. Other embodiments may be utilized and structural, and logical changes may be made without departing from the scope of the disclosure. The various embodiments are not necessarily mutually exclusive, as some embodiments can be combined with one or more other embodiments to form new embodiments.

Embodiments described in the context of one of the enclosure systems, devices or methods are analogously valid for the other systems, devices or methods. Similarly, embodiments described in the context of a system are analogously valid for a device or a method, and vice-versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

As used herein, the term “and/or” includes any and all combinations of one or more of the associated listed items.

As used herein, the term “data” may be understood to include information in any suitable analog or digital form, for example, provided as a file, a portion of a file, a set of files, a signal or stream, a portion of a signal or stream, a set of signals or streams, and the like. The term data, however, is not limited to the aforementioned examples and may take various forms and represent any information as understood in the art.

As used herein, the term “image data” refers to data in various formats that contain one or more location of interest having features such as, but not limited to, roads, buildings. Non-limiting examples of image data include satellite images, georeferenced maps in two-dimensional or three-dimensional form. Such image data may be stored in various file formats. Image data may comprise pixels (two-dimensional image), and voxels (three-dimensional image).

As used herein, the term “depth map” refers to a processed image data that contains information relating to the distance of the surfaces of scene objects from a viewpoint, for example, along the camera's principal axis. Various methods, including deep learning models can be trained to estimate the depth map using the image data as the only input. The term is related to and may be analogous to the following terms: depth buffer, Z-buffer, Z-buffering and Z-depth.

As used herein, the term “semantic segmentation” refers to the process of identifying one or more features on an image data file and assigning a label to one or more features (e.g. roads, lamp-post, vehicles, pedestrians, buildings, etc.) in the image data file for purpose of feature identification.

As used herein, the term “module” refers to, or forms part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor. A single module or a combination of modules may be regarded as a device.

As used herein, the term “node” refers to any computing device that has processing and communication capabilities. Non-limiting examples of nodes include a computer, a mobile smart phone, a computer server.

As used herein, the term “associate”, “associated”, and “associating” indicate a defined relationship (or cross-reference) between two items. For instance, a captured image data file may be associated with a location of interest or part thereof.

As used herein, “memory” may be understood as a non-transitory computer-readable medium in which data or information can be stored for retrieval. References to “memory” included herein may thus be understood as referring to volatile or non-volatile memory, including random access memory (“RAM”), read-only memory (“ROM”), flash memory, solid-state storage, magnetic tape, hard disk drive, optical drive, etc., or any combination thereof. Furthermore, it is appreciated that registers, shift registers, processor registers, data buffers, etc., are also embraced herein by the term memory. It is appreciated that a single component referred to as “memory” or “a memory” may be composed of more than one different type of memory, and thus may refer to a collective component including one or more types of memory. It is readily understood that any single memory component may be separated into multiple collectively equivalent memory components, and vice versa. Furthermore, while memory may be depicted as separate from one or more other components (such as in the drawings), it is understood that memory may be integrated within another component, such as on a common integrated chip.

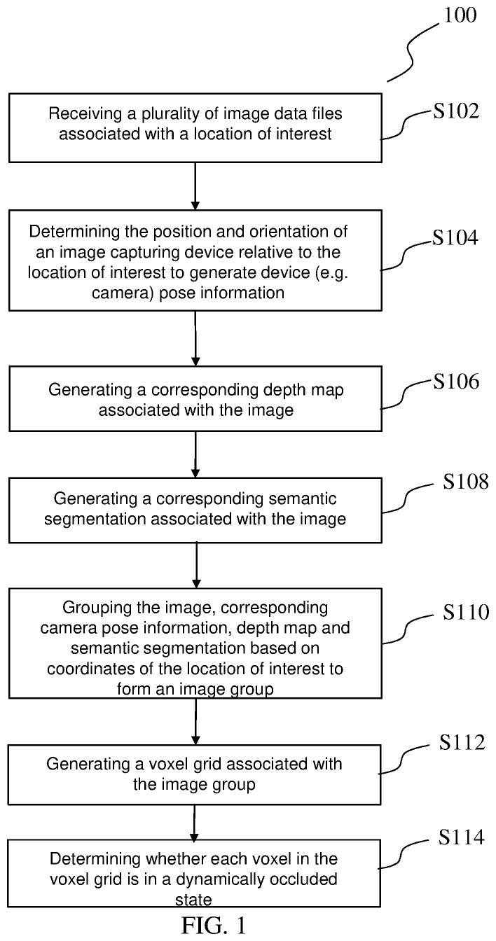

According with an aspect of the disclosure and referring to FIG. 1, there is a method 100 for detecting dynamic occlusion comprising the steps of: receiving a plurality of image data files associated with a location of interest (step S102), each image data file associated with at least a part of the location of interest; for each image associated with the location of interest, determining the position and orientation of an image capturing device relative to the location of interest to generate camera pose information (step S104); generating a corresponding depth map (step S106); generating a corresponding semantic segmentation (step S108); grouping the image, corresponding camera pose information, depth map and semantic segmentation based on coordinates of the location of interest to form an image group (step S110); generating a voxel grid associated with the image group (step S112); and determining whether each voxel in the voxel grid is in a dynamically occluded state (step S114).

The method 100 can suitably be implemented to detect dynamic occlusions on street view images covering one or more road networks associated with a location of interest. In step S102, the location of interest may be an area comprising the one or more road networks. The area may be an urban area comprising buildings, roads, and/or other landmarks. The one or more road networks may be utilized by vehicles that may be a source of dynamic occlusion. The plurality of image data files may be captured by a type of image capturing device (e.g. camera of a specific model) or may be captured by different types of image capturing devices (e.g. camera of various models, camcorders, video recorders). Each captured image data file may be associated with a part of the location of interest and may have contain location-based information specified by coordinates, for example latitude and longitude in the case of a two-dimensional image data file. In some embodiments, conditions are imposed to ensure that the quality of the captured images are at a certain standard, i.e. the images may be captured under relatively acceptable lighting conditions and without any blur or major view obstruction. In some embodiments, pre-processing may be done on one or more of the captured image data file. For example, image filter based on some quality metrics can be implemented and applied on the image data file(s). In some embodiments, the plurality of image data files may form a geographical map of the location of interest or part thereof.

In step S104, each of the captured images may be processed to estimate and generate a camera pose associated with each image, based on overlapping visual cues. The camera pose may include translation and rotation. In some embodiments, camera translation can be represented in a three-dimensional (3D) coordinate frame shared by all the cameras (also referred to as a world coordinate frame) and be converted to latitude and longitude. The parameters associated with camera rotation may be represented as a rotation matrix or a quaternion. In some embodiments, structure-from-motion (SfM) or simultaneous localization and mapping (SLAM) algorithms may be used to estimate the camera pose of each image. In the case that images are not associated with any geo-location, ground control points (GCP) may be used as reference to ensure the estimated camera translations are referred to a correct reference point and at the correct scale.

In step S106, the generation of a corresponding depth map associated with each image may include the use of a trained artificial intelligence (AI) model, such as a machine learning or deep learning model to estimate the depth map using the image as the only input. In some embodiments, the SfM may be used to output a relatively more accurate depth map using visual cues from neighboring images to provide better context.

In step S108, the generation of a semantic segmentation of the image involves the use of a segmentation model to identify objects or landmarks on the image, and accordingly label such landmarks or objects. In some embodiments, the segmentation model may include an AI model. The AI model may include one or more pre-trained Convolutional Neural Network (CNN) models configured to receive each image as an input and generating multiple semantic labels for each image. For street view imagery, the model can be fine-tuned or trained to be able to identify some specific features such as lamp posts, traffic lights, trees, buildings etc. around the vicinity of the road network(s) shown in the image.

In step S110, a possible criterion or condition used to group the image, corresponding camera pose information, depth map and semantic segmentation may be based on location which may be defined as coordinates. In some embodiments, if a map is used, a map-matching service may be utilized to match the image location to a certain feature, for example a road segment of the road network so that the related images may be grouped according to their matched segment. Without using a map, multiple images can be grouped based on their raw locations into a specified number of groups.

In step S112, the generation of a voxel grid is performed for each image group. Each voxel grid may comprise a plurality of voxels, and the generated voxel grid covers all the image locations within the image group. In some embodiments where map-matching is used, the coordinates of a road segment can be used to determine the length of the voxel grid and the width can be specified by the road width. To further cover the joint part of two consecutive road segments, the voxel grid can be extended towards both sides of a road segment by a certain distance, making the total length slightly bigger than the road segment in the image. In some embodiments, a bounding box of the image locations may be used to determine the width and length of the voxel grid. The height of the voxel grid can be set to the common height of the buildings found in the image group. The voxel size can be chosen according to the desired resolution of the occlusion detected.

The bounding points of each voxel in the voxel grid can be sampled and formed into a point set of which the state will be estimated in the subsequent steps.

In step S114, a state is assigned to each voxel in the voxel grid. The states may be selected from one of the following possible states: an unseen state, a dynamic occluded state, an occupied state, and a void state as will be elaborated.

In some embodiments, the method 100 may further include a step of generating a voxel grid state array comprising the states of each of the voxel in the voxel grid. In some embodiments, the voxel grid state array may be implemented as a one-dimensional array.

In some embodiments, the step of generating a voxel grid comprises determining the respective dimensions of the voxel grid, i.e. a length, a width and a height of the voxel grid. Each dimension may be defined in terms of the number of voxels along the respective axis. This may be based on using one or more identified feature on the image group, such as a road, as a reference point.

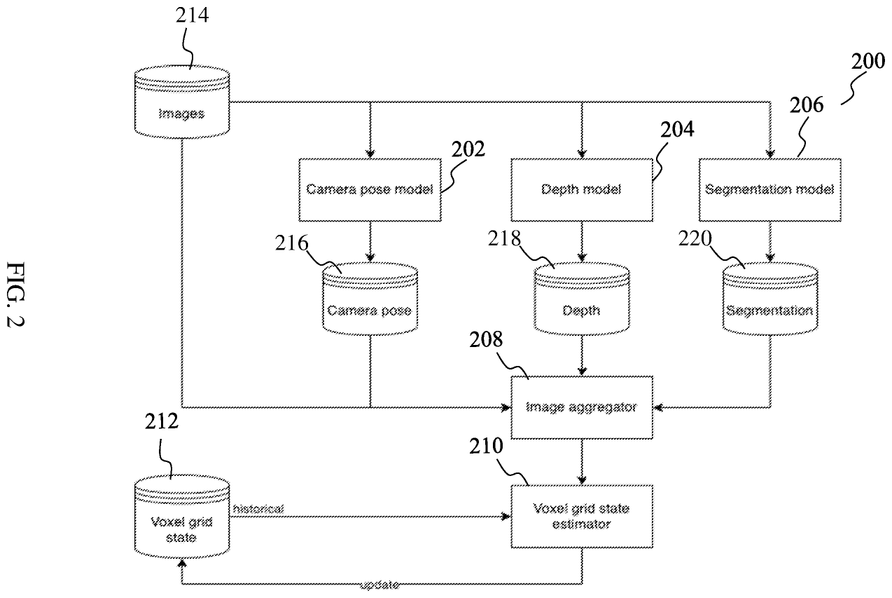

FIG. 2 shows an embodiment of the system 200 for detection of dynamic occlusion. The system 200 comprises a camera pose module 202, a depth map generation module 204, a segmentation module 206, an image aggregator 208 and a voxel grid state estimator 210.

The camera pose module 202, depth map generation module 204, and segmentation module 206 are configured or programmed to generate image-related information using computer vision techniques.

The camera pose module 202 is configured or programmed to estimate a camera pose associated with each image in accordance with step S104. This may include estimation on whether the image has been rotated and/or translated relative to a reference coordinate system.

The depth map generation module 204 is configured or programmed to output the corresponding or related depth map of each image, i.e. the depth of each pixel along the camera's principal axis, in accordance with step S106.

The segmentation module 206 is configured or programmed to generate and output the semantic segmentation of each image in accordance with step S108.

The image aggregator 208 is configured or programmed to group the images and related information according to some criteria, for example based on coordinates associated with a location of interest or feature according to step S110. In some embodiments, the image aggregator 208 aggregates the images and the related camera pose, depth and segmentation into groups based on image locations (coordinates).

The voxel grid state estimator 210 utilizes the image group and related information to estimate the state associated with a feature (e.g. a road) and detect dynamic occlusion in accordance with step S114. The state of the roads and the location of dynamic occlusion are stored in a voxel grid state database 212, which is may be updatable whenever new images are acquired. In some embodiments, the voxel grid state estimator 210 may be used to generate the voxel grid according to step S112.

In the embodiment shown in FIG. 2, the input images captured by one or more image capturing devices may be stored in a database 214. The database 214 may in turn be arranged in data communication with the camera pose module 202, the depth map generation module 204, and the segmentation module 206, the database 214 forming the input set with respect to the respective modules 202, 204, 206. The output of each of the camera pose module 202, the depth map generation module 204, and the segmentation module 206 may be stored in databases 216, 218 and 220 respectively. The image aggregator 208 is arranged with the databases 216, 218 and 220 to receive images and related information/data from the databases 216, 218 and 220 as input.

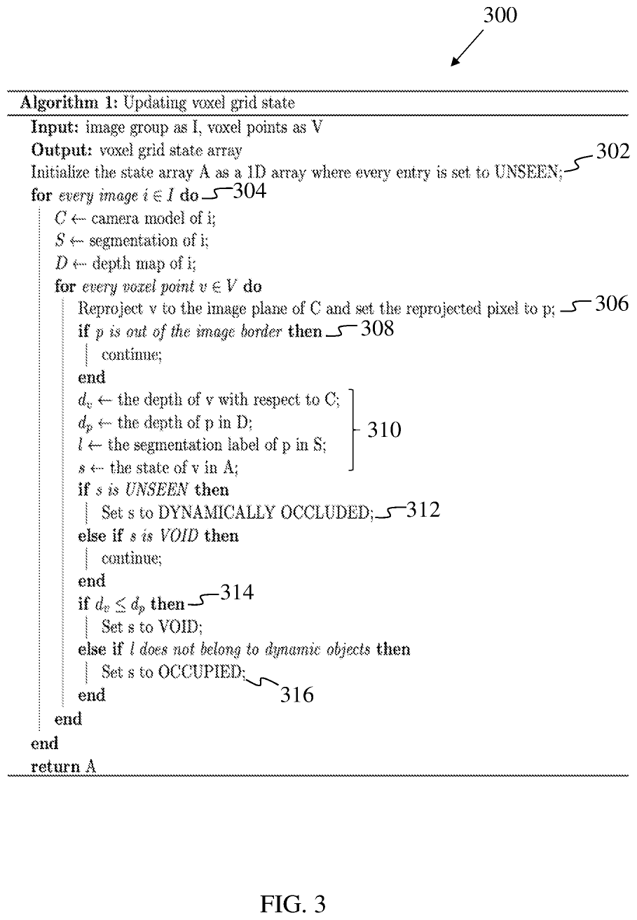

In some embodiments, the voxel grid state estimator 210 models and discretizes the space surrounding the image locations in the image group to form the voxel grid, which may be a large cuboid consisting of many small-sized voxels. Each voxel may be regarded as a 3D counterpart of a pixel, and may be a small cube occupying a predefined volume of space, for example one cubic meter (1 m³), and may be akin to a three-dimensional pixel. Upon creation of the voxel grid, the camera pose, depth and segmentation related information/data are used to determine the state of each voxel as dynamically occluded or not. In some embodiments, historical voxel grid state may be retrieved prior to the state determination if it is present in the database 212. The historical voxel grid state will then be updated based on the latest computation and written back to the database 212. A detailed description of how this component works is shown in FIG. 3.

FIG. 3 shows an example of the voxel grid state estimator 210 implementing a process 300 for updating the voxel grid state for each voxel in the voxel grid. Four possible states for each image data point sampled from the voxel grid are defined as follows.

Unseen state—This state refers to an image data point that cannot be seen from the cameras that are associated with the images processed so far. Technically, this refers to any image data point that is outside of the viewing frustum(s) of any camera.

Dynamically occluded state—This state means that the image data point is occluded by some dynamic object in the images processed.

Void state—This state means that the image data point is in the air. Once an image data point is deemed void, its state would always stay void and there is no need to check this point anymore.

Occupied state—This state means that the image data point is occupied by some static object as opposed to a dynamic object. Examples of static objects include buildings, lamp-posts.

In some embodiments, a one-dimensional array (list), referred to as the voxel grid state array, may be used to store the state of each sampled point. The value of each entry can only be one of the four states mentioned above.

In 302, when the array is initialized, every image data point is set to the “unseen” state. The camera pose information, segmentation information, and depth map associated with each image is grouped into a dataset C, S, and D respectively.

In 304, the voxel grid state estimator 210 then iterates over the points in the image group and updates the state of the points visible in each image.

In 306, the sampled voxel points v are reprojected onto the image plane of C and the reprojected two-dimensional pixels p are obtained.

In 308, pixels falling out of the image border (as specified by the image resolution) will be regarded as points outside of a predefined image frustum.

In 310, the parameter dᵥ representing the depth of the voxel point with respect to the camera, and the parameter dₚ representing the depth of the reprojected pixel

In 312, for the pixels within the image border, the states are assigned to be dynamically occluded until one or more conditions indicate the change of their state.

In 314, the distance of the point from the camera is compared to the depth of the reprojected pixel. If the distance of the point to the camera is smaller than the depth of the reprojected pixel, it means that the voxel point is in front of the object in the image and its state should be void. Otherwise, the segmentation label of the reprojected pixel will be checked. In 316, if the segmentation label doesn't belong to one of the dynamic objects, the state of the voxel point will change to occupied.

The algorithm shown in FIG. 3 works for estimating the voxel grid state from scratch, i.e. when there is no historical voxel grid state in the database. If the voxel grid state of a road segment is already present in the form of a historical voxel grid state array and it is desired to update the historical voxel grid state for any new images acquired, the initialization in 302 can be changed to the retrieval of the historical voxel grid state.

Once the voxel grid state array is updated, the corresponding voxel points in the dynamically occluded state can be selected as the final output. If a world coordinate system is used for purpose of specifying location, the 3-dimensional coordinates of those points can also be converted to longitude, latitude and altitude for easy reference. The updated array can be stored in the database as the latest historical voxel grid state array and retrieved again when the next update happens. To manage storage space more efficiently, and due to the deterministic nature of the voxel grid creation, only the configuration of the voxel grid, for instance the width, height and voxel size, needs to be stored as well. When using or updating the state array, the voxel grid can be created on the fly and aligned with the state array.

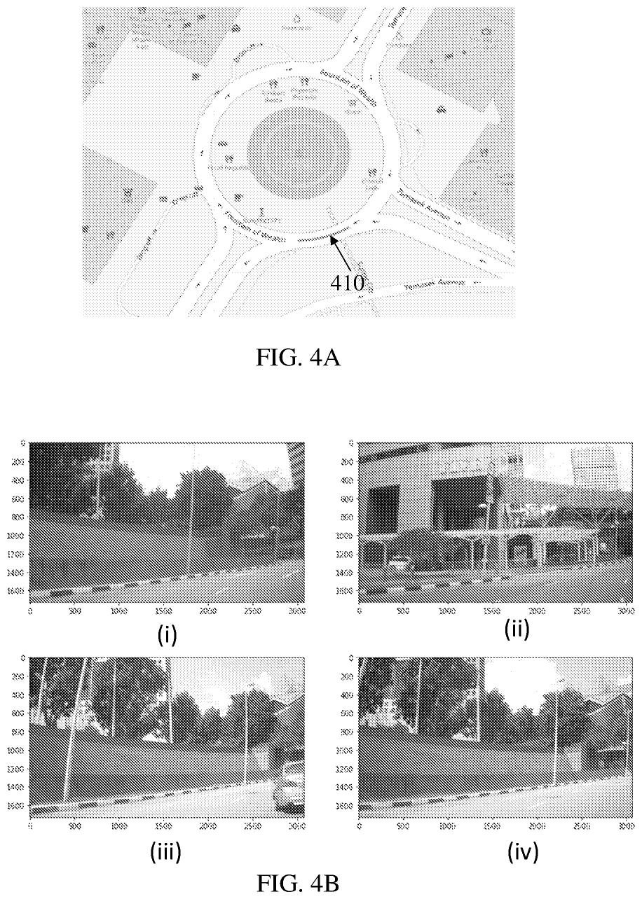

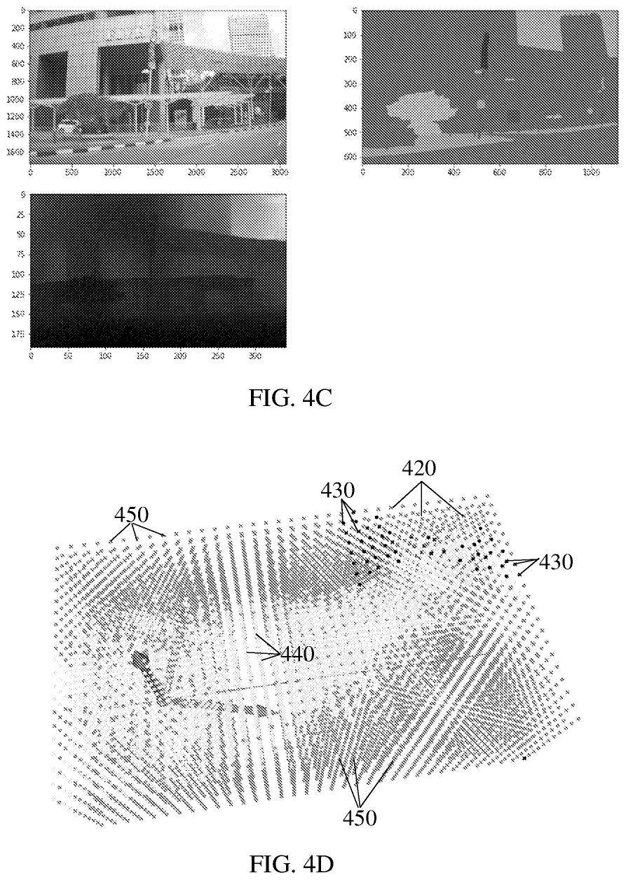

FIG. 4A to FIG. 4D show the application of the method 100 and 300 on an example road segment. The images are obtained from a location of interest in Singapore, having a road segment defined and marked as 410 in FIG. 4A. Seventy-nine street view images are map-matched to this road segment 410 and are processed for the corresponding voxel grid.

FIG. 4B shows four sampled street view images number i. to iv. obtained from the seventy-nine street view images. FIG. 4C shows the segmentation image and the depth map generated by the trained AI models for the second image FIG. 4B(ii).

FIG. 4D shows the state of the corresponding voxel grid after processing all seventy-nine images. The origin of the coordinate frame is set to be the end node of this road segment, and the underlying line marked 420 shows the road segment itself (extended 5 metres towards both ends). The width and height of the voxel grid may be set to scale and covers a real-world dimension of, for example, 20 metres and 10 metres respectively. Each voxel is a cube set to scale of a real-world dimension of 1 metre by 1 metre by 1 metre.

The points marked 420 are in the state “Unseen” in all seventy-nine images, and the points marked 430 (in darkened black) are dynamically occluded. The points marked 440 are in the state of void, meaning that there is nothing but air. The points marked 450 are occupied by the buildings on each side of the road. In total, fifty-eight points in this voxel grid are dynamically occluded, out of which five are sampled with coordinates (latitude, longitude, altitude) as follows.
(1.2945209864075151, 103.8591298415295, 1.000033344142139)
(1.2945071781013393, 103.85911516272319, 1.0000234749168158)
(1.2945132807329793, 103.85910399525002, 3.000020978040993)
(1.2945132807093065, 103.85910399522076, 4.000020977109671)
(1.2944994723450367, 103.85908931634063, 7.000012289732695)

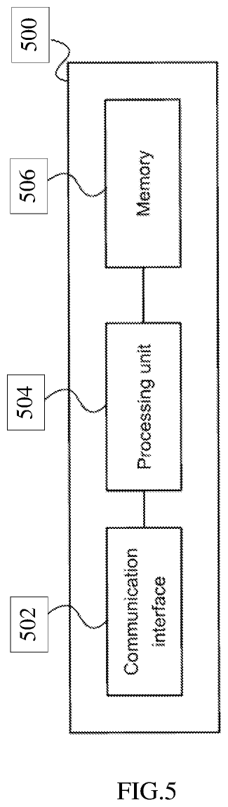

FIG. 5 shows a server computer 500 according to various embodiments. The server computer 500 includes a communication interface 502 (e.g. configured to receive input data from the one or more cameras or image capturing devices). The server computer 500 further includes a processing unit 504 and a memory 506. The memory 506 may be used by the processing unit 504 to store, for example, data to be processed, such as data associated with the input data and results output from one or more of databases 212, 214, 216, 218, 220. The server computer 500 is configured to perform the method of FIG. 1 and/or FIG. 3. It should be noted that the server computer system 500 can be a distributed system including a plurality of computers. The memory 506 may include a non-transitory computer readable medium.

In various embodiments, where artificial intelligence (AI) models are used, the AI model may be trained by supervised method, unsupervised method and/or a combination of the aforementioned.

It is contemplated that as addition or alternative to the specific AI algorithms as described, other algorithms such as evolutionary algorithms, expert rule-based systems may be used.

It is contemplated that the output of the method, system and/or device as described may be deployed in a control navigation system for updating of maps for access by users, such as a driver of a vehicle or a smartphone user for viewing street maps. For example, updates may be performed for map images identified to be not in a dynamic occluded state where previously the map images were in a dynamic occluded state.

The described system may be simple to implement in the context of street view maps because of the specific constraints associated with feature identification (e.g. road networks). The system as shown in FIG. 2 may achieve flexibility where the main components are independent of each other and can be upgraded separately for higher accuracy.

To mitigate the problem of storing and indexing the occlusions efficiently when the area covered by the imagery is very large, the storage may be reduced by saving only the configuration of voxel grids and the voxel grid state array (1-dimensional), instead of storing the occluded positions directly.

In some embodiments, where the map data are available, the location of interest can be defined beforehand and the update of map images based on newly available information relating to dynamic occlusion can be done on the fly.

The methods described herein may be performed and the various processing or computation units and the devices and computing entities described herein may be implemented by one or more circuits. In an embodiment, a “circuit” may be understood as any kind of a logic implementing entity, which may be hardware, software, firmware, or any combination thereof. Thus, in an embodiment, a “circuit” may be a hard-wired logic circuit or a programmable logic circuit such as a programmable processor, e.g. a microprocessor. A “circuit” may also be software being implemented or executed by a processor, e.g. any kind of computer program, e.g. a computer program using a virtual machine code. Any other kind of implementation of the respective functions which are described herein may also be understood as a “circuit” in accordance with an alternative embodiment.

While the disclosure has been particularly shown and described with reference to specific embodiments, it should be understood by those skilled in the art that various changes in form and detail may be made therein without departing from the spirit and scope of the disclosure as defined by the appended claims. The scope of the disclosure is thus indicated by the appended claims and all changes which come within the meaning and range of equivalency of the claims are therefore intended to be embraced.

1. A method for detecting dynamic occlusion on one or more images associated with a location of interest comprising the steps of:
receiving a plurality of image data files associated with a location of interest, each image data file associated with at least a part of the location of interest;
for each image
determining the position and orientation of an image capturing device relative to the location of interest and generating device pose information;
generating a corresponding depth map;
generating a corresponding semantic segmentation;
grouping the image, device pose information, depth map and semantic segmentation based on coordinates of the location of interest to form an image group;
generating a voxel grid associated with the image group; and
determining whether each voxel in the voxel grid is in a dynamically occluded state.

2. The method of claim 1, wherein the step of determining whether each voxel in the voxel grid is in a dynamically occluded state includes selecting a state from a set of states comprising the following states: unseen, dynamically occluded, void, and occupied.

3. The method of claim 1, further comprising the step of generating a voxel grid state array comprising the states of the each of the voxel in the voxel grid.

4. The method of claim 3, wherein the voxel grid state array is a one-dimensional array.

5. The method of claim 3, wherein at an initialization of the voxel grid state array, the state of every voxel is set to an unseen state.

6. The method of claim 5, further comprising the step of reprojecting the voxel onto a two-dimensional image plane based on the device pose information, and obtaining an associated two-dimensional pixel.

7. The method of claim 6, further comprising a step of determining if the pixel is out of an image border specified by the image resolution, and assigning the dynamic occluded state to the voxel if the associated pixel is determined to be within the image border.

8. The method of claim 7, further comprises comparing a first parameter dᵥ representing a depth of the voxel point with respect to the image capturing device, with a second parameter dₚ representing the depth of the reprojected pixel, wherein if dᵥ is less than or equal to dₚ, the voxel is assigned the void state.

9. The method of claim 8, further comprises checking if the segmentation label of the reprojected pixel is a dynamic object, and if not, the voxel will be assigned the occupied state.

10. The method of claim 1, wherein the step of grouping comprises matching the location of interest with at least one feature on a reference map.

11. The method of claim 10, wherein the step of generating a voxel grid comprises determining a length, a width and a height of the voxel grid based on the at least one feature on the reference map.

12. The method of claim 1, wherein the step of generating the corresponding depth map of the image comprises using a trained deep learning model or a structure-from-motion (SfM) algorithm to estimate the depth map using the image as the only input.

13. The method of claim 1, wherein the step of generating a corresponding semantic segmentation of the image comprises using a trained convolutional neural network model to generate semantic labels associated with one or more features on the image.

14. A device for detecting dynamic occlusion on one or more images associated with a location of interest comprising
an input module configured to receive a plurality of image data files associated with a location of interest;
a device pose module configured to determine the position and orientation of an image capturing device relative to the location of interest and generating device pose information;
a depth map generation module configured to generate a corresponding depth map;
a segmentation module configured to generate a corresponding semantic segmentation;
an image aggregator module configured to group the image, device pose information, depth map and semantic segmentation based on coordinates of the location of interest to form an image group;
a voxel grid state estimator configured to generate a voxel grid associated with the image group; and determine whether each voxel in the voxel grid is in a dynamically occluded state.

15. The device of claim 14, wherein determination of whether each voxel in the voxel grid is in a dynamically occluded state includes selecting a state from a set of states comprising the following: unseen state, dynamically occluded state, void state, and occupied state.

16. The device of claim 14, or wherein the voxel grid state estimator is further configured to generate a voxel grid state array comprising the states of the each of the voxel in the voxel grid.

17. The device of claim 16, wherein the voxel grid state array is a one-dimensional array.

18. A system for updating a voxel grid state array comprising the device of claim 16, further comprising an updater to check if the voxel is previously detected to be in a dynamic occluded state and subsequently in a void state or occupied state.

19. The system of claim 18, wherein if the voxel is detected to be in a void state or occupied state, the system is configured to update the voxel grid state array associated with the change of state(s).

20. A non-transitory computer-readable storage medium comprising instructions, which, when executed by one or more processors, cause the execution of the method according claim 1-13.
